(19) United States
(12) Patent Application Publication
(10) Pub. No.: US 2026/0272620 A1
(43) Pub. Date: Sep. 17, 2026

(54) AUXILIARY SCANNING AND DATA CORRECTION APPARATUS AND METHOD FOR EDENTULOUS IMPLANT IMPRESSIONS

(71) Applicant: SICHUAN UNIVERSITY, Chengdu (CN)

(72) Inventors: Shengtao Yang, Chengdu (CN); Quan Yuan, Chengdu (CN); Li Yue, Chengdu (CN)

(21) Appl. No.: 19/467,806

(22) Filed: Feb. 3, 2026

(30) Foreign Application Priority Data
Mar. 7, 2025 (CN) 202510266660.2

(51) Int. Cl. A61C 9/00; G06T 7/00; G06T 7/10; G06T 17/20

(52) U.S. Cl. CPC A61C 9/0053; G06T 7/0012; G06T 7/10; G06T 17/20; G06T 2200/04; G06T 2207/30036; G06T 2210/41

(57) ABSTRACT

An auxiliary scanning and data correction apparatus and method for edentulous implant impressions are disclosed. The apparatus includes an arc-shaped base plate configured to conform to the tooth bed and palate of an edentulous patient; and the arc-shaped base plate is provided with a slot configured to accommodate scan bodies on implants. The data correction method includes: performing virtual segmentation on composite data according to the number of scan bodies to obtain segmented composite data segments corresponding to the number of scan bodies; finding correction standard data of an apparatus according to an identification number of the apparatus, and correcting the segmented composite data segments to obtain a corrected scan model; and assisting in implant treatment for an edentulous patient using the corrected scan model.

### CROSS-REFERENCE TO RELATED APPLICATION

The present application claims priority from Chinese Patent Application No. 202510266660.2 filed on Mar. 7, 2025, the contents of which are incorporated herein by reference in their entirety.

### TECHNICAL FIELD

The present invention relates to the technical field of edentulous implant, and in particular, to an auxiliary scanning and data correction apparatus and method for edentulous implant impressions.

### BACKGROUND

In the implant treatment process for an edentulous patient, precisely transferring the spatial position of the implants/abutments inside the patient's mouth to an extraoral digital model through digital impression acquisition technology is a most important and essential step. High-precision impression acquisition can well achieve passive seating of the superstructure in edentulous implant fixed restoration, thereby reducing mechanical and biological complications and ensuring the long-term success rate of edentulous implant treatment.

Currently, the commonly used digital impression acquisition technology is intraoral scanning technology. In the acquisition process of an intraoral scanned edentulous implant impression, it is first necessary to use matching screws to fix metal or non-metal scan bodies with special structural surfaces onto the upper part of the implants/abutments inside the patient's mouth. Then, an intraoral scanner is employed to scan the fixed scan bodies and the surrounding soft tissues such as the gingiva of the patient, thereby obtaining the final digital impression that reflects the scan bodies and their surrounding tissues inside the patient's mouth. However, since the intraoral scanner mainly achieves impression acquisition through a data stitching process, and the oral tissue structure of edentulous implant patients is special: the surface is smooth, reflective, and lacks obvious, easily identifiable anatomical landmarks, it is disadvantageous for data acquisition and stitching. Meanwhile, the spans between implants in edentulous implant patients are often large, leading to a high number of data stitching operations, which easily causes accumulation of stitching errors. This results in the acquired digital intraoral scanned impression failing to meet clinical requirements for precision. Currently, it is difficult to acquire a high-precision edentulous implant impression solely through an intraoral scanner.

Existing auxiliary apparatuses can be fixed on scan bodies and typically have special structures on their surfaces, promoting the scanning and matching process of the intraoral scanning device through the surface structures. However, these apparatuses cannot circumvent the deficiency of data stitching deformation inherent in scanners. For the impression acquisition of edentulous implant patients, as the scanning path lengthens, the problem of scanning and stitching errors by intraoral scanners still persists. Using these auxiliary apparatuses alone cannot avoid the problem of stitching deformation during long-path scanning.

### SUMMARY

The inventive object of the present invention is: in view of the above problems, to provide an auxiliary scanning and data correction apparatus and method for edentulous implant impressions, which is expected to ameliorate the problems that since the oral tissue structure of edentulous implant patients is special, i.e., the surface is smooth, reflective, and lacks obvious, easily identifiable anatomical landmarks, it is disadvantageous for data acquisition and stitching; and that existing apparatuses cannot circumvent the deficiency of data stitching deformation inherent in scanners.

The technical solution adopted by the present invention is as follows: an auxiliary scanning and data correction apparatus for edentulous implant impressions includes an arc-shaped base plate configured to conform to the tooth bed and palate of an edentulous patient; the arc-shaped base plate is provided with a slot configured to accommodate scan bodies on implants; and the surface of the arc-shaped base plate has a matte structure and is provided with irregular patterns configured to assist in scanning recognition, stitching, and data correction.

Further, to clearly distinguish a coverage range of the apparatus, the apparatus comprises a maxillary apparatus and a mandibular apparatus, wherein a coverage range of the maxillary apparatus extends from a labial-buccal side to a mucogingival junction, a palatal side covers a palatal vault with small convexity, and a posterior border extends to a palatal fovea; and a coverage range of the mandibular apparatus extends from the labial-buccal side to a mucogingival junction, and a region near a lingual side is relatively flat.

Further, to adapt to the varying oral dimensions of edentulous patients, the apparatus is provided in four different sizes, S, M, L, and XL, by means of 3D reverse modeling according to average values of human dental arch length and width; and an inner surface of the apparatus conforms to the morphology of the alveolar ridge of an edentulous patient.

It should be noted that the 3D reverse modeling is an existing software.

Further, for the safety of patients, the apparatus is made of resin, metal, PEEK or a medical material.

Further, to avoid deviation in scan data, an auxiliary scanning and data correction method for edentulous implant impressions is proposed. The auxiliary scanning method comprises:
numbering the apparatus, and scanning the apparatus by a high-precision three-dimensional scanning device to obtain three-dimensional surface data of the apparatus, wherein an identification number of the apparatus is in one-to-one correspondence with the three-dimensional surface data of the apparatus;
installing scan bodies on implants in the tooth bed of an edentulous patient, selecting an apparatus of an appropriate size according to the size of the dental arch of the edentulous patient and the positions and angles of the implants, and recording an identification number of the apparatus used;
matching a slot of the apparatus with the scan bodies, and connecting the apparatus to the scan bodies; and
scanning the apparatus and the scan bodies using an intraoral scanner, and capturing identification features on surfaces of the scan bodies and irregular images on the surface of the apparatus, to obtain composite data comprising the apparatus and the scan bodies.

Further, to make reference data for correction more precise, the apparatus is scanned by a high-precision three-dimensional scanning device, and three-dimensional surface data of the apparatus obtained by scanning is taken as correction standard data.

Further, to output a high-precision scan model, the data correction method comprises:
performing virtual segmentation on the composite data according to the number of the scan bodies to obtain segmented composite data segments corresponding to the number of the scan bodies;
finding the correction standard data of the apparatus according to the identification number of the apparatus, and correcting the segmented composite data segments to obtain a corrected scan model; and
assisting in implant treatment for the edentulous patient using the corrected scan model.

Further, to segment the composite data based on the scan bodies, the segmented composite data segments comprise irregular images on a corresponding part of the surface of the apparatus and corresponding scan bodies.

Further, the correcting the segmented composite data segments specifically comprises the following steps:
matching the segmented composite data segments with corresponding correction standard data using matching AI-assisted correction software or dental design software, and adjusting data in the segmented composite data segments and irregular images on the surface of the apparatus based on the correction standard data to obtain the scan model.

It should be noted that the dental design software is an existing software.

Further, to improve the efficiency of scanning and data correction, the data correction is configured in the intraoral scanner, and performed simultaneously while the oral cavity of the edentulous patient is scanned, and a scan model output therefrom is transmitted via a signal to a PC for display and storage.

To sum up, due to the adoption of the above technical solution, the present invention has the beneficial effects as follows:
1. Due to difficulties such as the lack of clear anatomical landmarks and significant mobility of mucosal tissues during intraoral scanning of edentulous patients, an auxiliary scanning apparatus for edentulous implant impressions is provided. The intraoral scanner scans the auxiliary scanning apparatus for edentulous implant impressions instead of directly scanning the patient's oral cavity, which improves the accuracy of scan data, facilitates recognition, capture, and stitching during scanning by the intraoral scanner, reduces scanning time, and enhances scanning precision.
2. Since existing auxiliary apparatuses for intraoral scanning cannot avoid the problem of stitching deformation during long-path scanning, according to the present invention, longer paths are divided into shorter paths by segmenting the scan data (each segmented composite data segment corresponding to one scan body and irregular images on a corresponding part of the surface of the apparatus), thereby improving the accuracy of scanning, and reducing the probability of data stitching deformation during long-span scanning in edentulous implant cases by the intraoral scanner.
3. The apparatus is scanned by a high-precision three-dimensional scanning device to obtain three-dimensional surface data of the apparatus, the three-dimensional surface data are used as correction standard data, and the scanned composite data are corrected through the correction standard data, thereby improving the accuracy of the scan model.

### BRIEF DESCRIPTION OF DRAWINGS

FIG. 1 shows a structure diagram of an apparatus according to the present invention;

FIG. 2 shows a flowchart of an auxiliary scanning method according to the present invention;

FIG. 3 shows a flowchart of a data correction method according to the present invention;

FIG. 4 shows a maxillary apparatus according to the present invention;

FIG. 5 shows a mandibular apparatus according to the present invention; and

FIG. 6 shows a detailed structure diagram of the apparatus according to the present invention.

Reference numerals: 1, apparatus; 2, arc-shaped base plate; 3, slot; 4, scan body; 5, maxillary apparatus; 6, mandibular apparatus; 201, protrusion structure; 202, recess structure; 301, inner slot wall; 302, outer slot wall.

### DETAILED DESCRIPTION

The present invention will be described in detail below with reference to the accompanying drawings.

To make the object, technical solution, and advantages of the present invention clearer, the present invention will be further described in detail below in conjunction with the accompanying drawings and embodiments. It should be understood that the specific embodiments described herein are only used to explain the present invention and are not intended to limit the present invention.

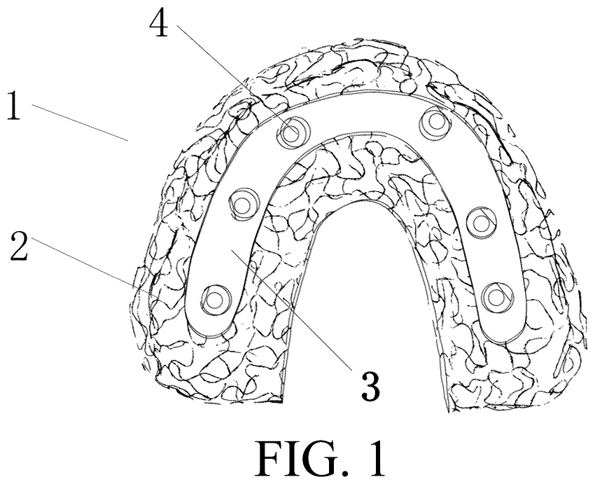

As shown in FIG. 1, since the intraoral scanner mainly achieves impression acquisition through a data stitching process, and the oral tissue structure of edentulous implant patients is special: the surface is smooth, reflective, and lacks obvious, easily identifiable anatomical landmarks, it is disadvantageous for data acquisition and stitching. Meanwhile, the spans between implants in edentulous implant patients are often large, leading to a high number of data stitching operations, which easily causes accumulation of stitching errors. This results in the acquired digital intraoral scanned impression failing to meet clinical requirements for precision. Currently, it is difficult to acquire a high-precision edentulous implant impression solely through an intraoral scanner.

As shown in FIGS. 1 to 6, an auxiliary scanning and data correction apparatus for edentulous implant impressions is provided. The apparatus 1 includes an arc-shaped base plate 2 configured to conform to the tooth bed and palate of an edentulous patient; the arc-shaped base plate 2 is provided with a slot 3 configured to accommodate scan bodies 4 on implants; and the surface of the arc-shaped base plate 2 has a matte structure and is provided with irregular patterns configured to assist in scanning recognition, stitching, and data correction.

The surface of the apparatus 1 is matte and features irregular characteristic structures, such as circular, triangular, square, thick curved, and wrinkled shapes. Thereby, this can solve the problem that “the surface is smooth, reflective, and lacks obvious, easily identifiable anatomical landmarks” in the oral tissues of edentulous patients, thereby facilitating recognition, capture, and stitching by the intraoral scanner.

Particularly, an auxiliary scanning and data correction method for edentulous implant impressions is provided to solve the problem that existing auxiliary apparatuses “cannot avoid model stitching deformation during long-path scanning”.

The auxiliary scanning method includes:
numbering the apparatus 1, scanning the apparatus 1 by a high-precision three-dimensional scanning device to obtain three-dimensional surface data of the apparatus 1, where an identification number of the apparatus is in one-to-one correspondence with the three-dimensional surface data of the apparatus 1;
installing scan bodies 4 on implants in the tooth bed of an edentulous patient, selecting an apparatus 1 of an appropriate size according to the size of the dental arch of the edentulous patient and the positions and angles of the implants, and recording an identification number of the apparatus 1 used;
matching the slot 3 of the apparatus 1 with the scan bodies 4, and connecting the apparatus 1 to the scan bodies 4, where the apparatus 1 is connected to the scan bodies 4 through occlusal registration silicone, hand-molded silicone, or other medical materials, and it is ensured that all scan bodies 4 can protrude through the slot 3; and
scanning the apparatus 1 and the scan bodies 4 by an intraoral scanner, and capturing identification features on surfaces of the scan bodies 4 and irregular images on the surface of the apparatus 1, to obtain composite data including the apparatus 1 and the scan bodies 4.

The data correction method includes:
performing virtual segmentation on the composite data according to the number of the scan bodies 4 to obtain segmented composite data segments corresponding to the number of the scan bodies 4, where each segmented segment includes one scan body 4 and a part of the apparatus 1, thereby dividing the entire composite data into multiple segments;
finding correction standard data of the apparatus 1 according to the identification number of the apparatus 1, correcting the segmented composite data segments, comparing the plurality of segments with the correction standard data respectively, and correcting data with a large deviation through the correction standard data to obtain a corrected scan model, where the data in the scan model is data that best fit the patient's oral condition after correction based on the edentulous patient's oral data; and
assisting in implant treatment for the edentulous patient using the scan model.

The method decomposes the stitching errors accumulated during long-span scanning, thereby fundamentally reducing the problem of data stitching deformation during long-span scanning in edentulous implant cases by the intraoral scanner, and achieving data correction functionality that previous auxiliary apparatuses could not achieve.

### Embodiment 1

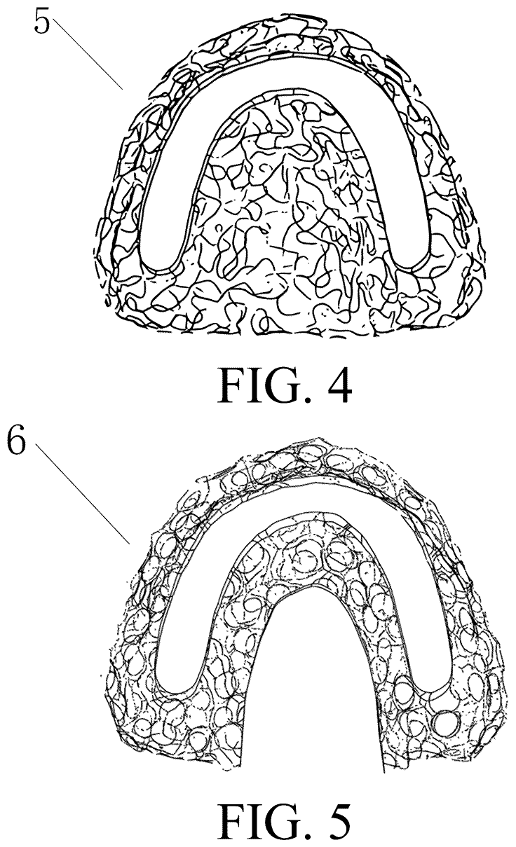

As shown in FIGS. 4-5, according to one embodiment of the present invention, to clearly distinguish a coverage range of the apparatus 1, the apparatus 1 includes a maxillary apparatus 5 and a mandibular apparatus 6. A coverage range of the maxillary apparatus 5 extends from a labial-buccal side to a mucogingival junction, a palatal side covers a palatal vault with small convexity, and a posterior border extends to a palatal fovea. A coverage range of the mandibular apparatus 6 extends from the labial-buccal side to a mucogingival junction, and a region near a lingual side is relatively flat.

Since the structures of the maxilla and mandible in the oral cavity differ significantly, the apparatus 1 is distinguished into the maxillary apparatus 5 and the mandibular apparatus 6, facilitating better adaptation to the internal structure of the patient's oral cavity. The coverage range of the maxillary apparatus 5 extends from the labial-buccal side to the mucogingival junction and from the palatal vault to the palatal fovea. The extended length of the maxillary apparatus enables the maxillary apparatus to be better fixed on the maxilla, facilitating subsequent scanning by the intraoral scanner. The coverage range of the mandibular apparatus 6 extends from the labial-buccal side to the mucogingival junction. Since the lingual side of the mandible is obstructed by the tongue, the mandibular apparatus is designed to have a relatively flat characteristic region.

The region covered by the apparatus 1 is a region with a smooth, reflective surface that lacks obvious, easily identifiable anatomical landmarks, which is difficult for the intraoral scanner to distinguish. Furthermore, the surface of the arc-shaped base plate 2 of the apparatus 1 has a matte structure and is provided with irregular patterns. Consequently, the intraoral scanner can recognize the irregular patterns on the surface of the apparatus 1 during scanning, thereby facilitating data capture and recognition, and reducing scanning time. Simultaneously, the irregular patterns are used for post-scan data correction, thereby enhancing scanning accuracy.

### Embodiment 2

According to one embodiment of the present invention, the apparatus 1 is provided in four different sizes, S, M, L, and XL, by means of 3D reverse modeling according to average values of human dental arch length and width; and an inner surface of the apparatus 1 conforms to the morphology of the alveolar ridge of an edentulous patient.

3D reverse modeling software is a tool for modeling based on physical objects, which can create a 3D representation of an existing structure through techniques such as 3D scanning and convert the 3D representation into a triangular mesh or polygonal mesh. Four different sizes (S, M, L, XL) of the auxiliary correction apparatus 1 are designed through 3D reverse modeling software according to the average values of human dental arch length and width. The inner surface of the apparatus 1 conforms to the morphology of the alveolar ridges of different edentulous patients, an outer surface of the apparatus exhibits a unique, irregular, and non-repeating structural feature, and the morphology thereof can be irregular patterns such as circular, triangular, square, thick curved, and wrinkled shapes, or a combination thereof. A slot 3 is provided in the middle of the apparatus 1 to accommodate intraoral scan bodies 4 installed in the patient's mouth and to secure the apparatus 1 onto the scan bodies 4.

According to the sizes of the oral cavity and alveolar ridge of the edentulous patient, an apparatus 1 of an appropriate size is selected, placed on the alveolar ridge, and connected to the scan bodies 4, so as to cover regions of the patient's oral cavity that are relatively smooth and disadvantageous for scanning by the intraoral scanner.

### Embodiment 3

According to one embodiment of the present invention, the apparatus 1 is made of resin, metal, PEEK or a medical material.

The material of the apparatus 1 is primarily considered to be non-polluting, harmless, morphologically stable and durable, and easy to disinfect, and irregular patterns thereon need to be easily identifiable to facilitate recognition by the intraoral scanner.

Resin has the characteristics of low weight and comfort, and can reduce the foreign body sensation in the oral cavity. Meanwhile, doctors can easily fabricate the apparatus chairside, and the apparatus can be appropriately adjusted after fabrication to ensure the fit of the apparatus 1 with the oral cavity, thereby improving wearing comfort.

Metal materials have the characteristics of corrosion resistance and wear resistance, and have low sensitivity to temperature, so the apparatus 1 will not be damaged by the temperature in the patient's mouth or the storage temperature, and can be reused after disinfection.

PEEK has stable performance and good biocompatibility, is wear-resistant and has a non-reflective surface, which can ensure that the apparatus 1 is accurately recognized and captured by the intraoral scanner. Meanwhile, PEEK has a low density, so the apparatus is more stable and comfortable after being installed in the patient's mouth.

Medical materials integrate various advantages, such as high strength, high biocompatibility, good wear resistance and corrosion resistance. These materials are increasingly widely used in the field of oral medicine and can meet patients' comprehensive needs for aesthetics, comfort, and durability.

### Embodiment 4

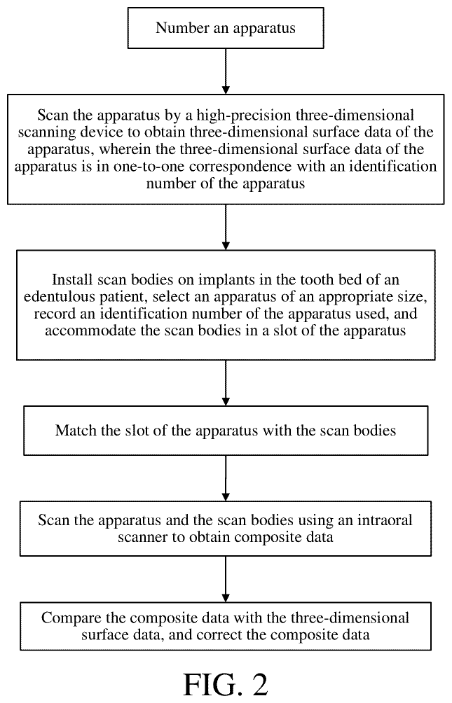

As shown in FIG. 2, according to one embodiment of the present invention, the auxiliary scanning method includes:
numbering the apparatus 1 for distinction; scanning the apparatus 1 by a high-precision three-dimensional scanning device to obtain three-dimensional surface data of the apparatus 1, where an identification number of the apparatus is in one-to-one correspondence with three-dimensional surface data of the apparatus 1; and the three-dimensional surface data can be stored in an intraoral scanner or matching AI-assisted correction software for convenient query and comparison;
installing scan bodies 4 on implants in the tooth bed of an edentulous patient, selecting an apparatus 1 of an appropriate size according to the size of the dental arch of the edentulous patient and the positions and angles of the implants, and recording the identification number of the apparatus 1 used, where the scan bodies 4 are configured to assist the intraoral scanner in positioning and can also fix the apparatus 1. Therefore, the apparatus 1 needs to be of an appropriate size to accommodate the scan bodies 4 in the slot 3 of the apparatus 1;
matching the slot 3 of the apparatus 1 with the scan bodies 4, and connecting the apparatus 1 to the scan bodies 4, where the selected apparatus 1 is fixed onto the scan bodies 4 inside the patient's mouth using occlusal registration silicone rubber/hand-mixed silicone rubber or other medical materials, and it is ensured that all scan bodies 4 can protrude through the slot 3 of the apparatus 1, and that identification features on surfaces of the scan bodies 4 are not obstructed by the silicone rubber or the selected apparatus 1; and
after the silicone rubber solidifies, scanning the apparatus 1 and the scan bodies 4 by the intraoral scanner, and capturing identification features on surfaces of the scan bodies 4 and irregular images on the surface of the apparatus 1, to obtain composite data including the apparatus 1 and the scan bodies 4.

The three-dimensional surface data of the apparatus 1 obtained by scanning with the aforementioned high-precision three-dimensional scanning device is taken as correction standard data, and then data correction is started.

By using the apparatus 1 to assist the intraoral scanner in scanning, the spatial position of the implants/abutments inside the patient's mouth can be precisely transferred to an extraoral digital model through digital impression acquisition technology. High-precision impression acquisition can better achieve passive seating of the superstructure in edentulous implant fixed restoration, thereby reducing mechanical and biological complications and ensuring the long-term success rate of edentulous implant treatment.

### Embodiment 5

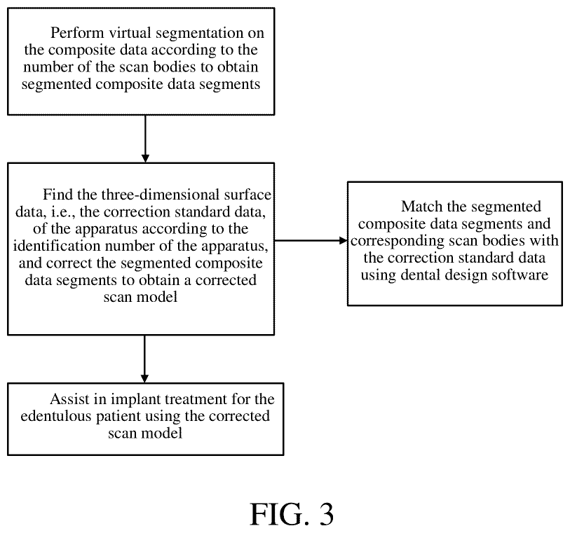

As shown in FIG. 3, according to one embodiment of the present invention, the data correction method includes:
performing virtual segmentation on the composite data obtained by the auxiliary scanning method according to the number of the scan bodies 4 to obtain segmented composite data segments corresponding to the number of the scan bodies 4;
finding the correction standard data of the apparatus 1 according to the identification number of the apparatus 1, and correcting the segmented composite data segments to obtain a scan model; and
assisting in implant treatment for the edentulous patient using the scan model.

The segmented composite data segments include irregular images on a corresponding part of the surface of the apparatus 1 and corresponding scan bodies 4.

The auxiliary apparatus 1 and the corresponding correction method can effectively improve the efficiency and accuracy of intraoral scanned edentulous implant impression acquisition, thereby obtaining a high-precision intraoral scanned edentulous implant model that meets clinical requirements and cannot be obtained by existing auxiliary apparatuses 1. Meanwhile, digital data of the apparatus 1 can be built into the intraoral scanner to undergo automatic identification and correction during scanning. This data can also be used in combination with matching AI-assisted correction software to undergo automatic identification, segmentation, correction, and data output, which can effectively save time for clinical intraoral scanned edentulous implant impression acquisition. The apparatus 1 can be reused, thereby saving materials and costs.

### Embodiment 6

As shown in FIG. 3, according to one embodiment of the present invention, the correcting the segmented composite data segments specifically includes the following steps:
matching the segmented composite data segments and corresponding scan bodies with the correction standard data using matching AI-assisted correction software or dental design software, and adjusting data in the segmented composite data segments and irregular images on the surface of the apparatus 1 based on the correction standard data, to obtain the scan model.

The dental design software plays a crucial role in the field of digital dentistry, enabling doctors and technicians to design precise dental restoration plans on a computer. The dental design software and the matching AI-assisted correction software used in the present embodiment are both existing technologies. Through the dental design software, the scanned composite data can be corrected, thereby designing a more suitable edentulous implant treatment plan for each patient.

### Embodiment 7

According to one embodiment of the present invention, the data correction is configured in the intraoral scanner, and performed simultaneously while the oral cavity of the edentulous patient is scanned, and a scan model output therefrom is transmitted via a signal to a PC for display and storage.

The intraoral scanner stores the correction standard data in advance. The composite data obtained after scanning is compared with the correction standard data, and the composite data is corrected to output the scan model. The data of the scan model avoids the problems that existing intraoral scanners cannot avoid data stitching errors during long-span intraoral scanning and that the scanned data lacks easily identifiable anatomical landmarks.

### Embodiment 8

According to another embodiment of the present invention, according to the number of implants in the patient's mouth, the scanning of the scan bodies 4 is performed segmentally. The irregular structures on part of the surface of the apparatus 1 and the corresponding scan bodies 4 are scanned respectively. The intraoral scanner automatically identifies the scanned irregular morphological part of the apparatus 1, and automatically matches the scanned data segments to the correction standard data of the apparatus 1 with the corresponding identification number stored in the intraoral scanner through the irregular structures on the surface of the apparatus 1, thereby achieving the functions of scanning, matching, and correcting data simultaneously. Finally, upon completion of scanning, a high-precision scan model is output.

Integrating the scanning and correction functions into the intraoral scanner enables the matching and correction of the scanned composite data and the correction standard data while the intraoral scanner is scanning, thereby improving the efficiency of outputting the scan model and efficiently proposing an oral treatment plan for the edentulous patient.

### Embodiment 9

According to another embodiment of the present invention, the obtained overall scanned composite data is imported into the matching AI-assisted correction software, and the unique identification number of the selected auxiliary correction apparatus 1 is input into the software. The software automatically calls the internally stored correction standard data of the apparatus 1, and, in combination with an AI algorithm, automatically identifies the scan bodies 4 and the surrounding auxiliary correction apparatus in the scanned data, and automatically performs segmentation of the scanned composite data by segmenting the data into a corresponding number of segments according to the number of scan bodies 4. Then, the software automatically matches the segmented segments to the built-in correction standard data of the apparatus 1, thereby achieving correction of the scanned composite data and output of the final data.

This method, combined with the AI algorithm, automatically segments the scanned composite data and then performs comparative correction with the correction standard data, which greatly reduces manual labor while improving data accuracy.

### Embodiment 10

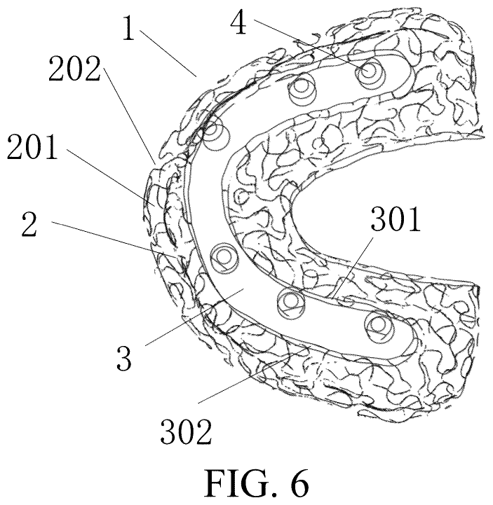

As shown in FIG. 6, according to another embodiment of the present invention, a detailed structural schematic diagram of the apparatus 1 is shown in FIG. 6. The arc-shaped base plate 2 is provided with protrusion structures 201 and recess structures 202. The protrusion structures 201 and the recess structures 202 constitute irregular patterns on the surface of the arc-shaped base plate 2. The slot 3 is provided with an inner slot wall 301 and an outer slot wall 302 near both sides of the arc-shaped base plate 2.

Compared with a case where the inner surface of the oral cavity of an edentulous patient without the apparatus 1 installed is smooth and lacks special markings, the apparatus 1 enables the intraoral scanner to accurately identify the protrusion structures 201 and the recess structures 202 on the surface of the arc-shaped base plate 2, making the scanned data more accurate.

The irregular patterns on the surface of the arc-shaped base plate 2 may be in the form of spherical, irregular polygonal, or corrugated shapes, specifically configured according to actual scanning conditions.

The above description is merely the preferred embodiments of the present invention and is not intended to limit the present invention. Any modifications, equivalent replacements, and improvements made within the spirit and principles of the present invention shall be included within the scope of protection of the present invention.

1. An auxiliary scanning and data correction apparatus for edentulous implant impressions, characterized by comprising an arc-shaped base plate configured to conform to the tooth bed and palate of an edentulous patient; and the arc-shaped base plate is provided with a slot configured to accommodate scan bodies on implants;
the surface of the arc-shaped base plate has a matte structure and is provided with irregular patterns configured to assist in scanning recognition, stitching, and data correction; the data correction is configured in an intraoral scanner, and is performed simultaneously while the oral cavity of an edentulous patient is scanned;
the apparatus comprises a maxillary apparatus and a mandibular apparatus, wherein a coverage range of the maxillary apparatus extends from a labial-buccal side to a mucogingival junction, a palatal side covers a palatal vault with small convexity, and a posterior border extends to a palatal fovea; a coverage range of the mandibular apparatus extends from the labial-buccal side to a mucogingival junction, and a region near a lingual side is relatively flat; the apparatus is made of resin, metal, PEEK or a medical material; the apparatus is numbered, and an identification number of the apparatus is in one-to-one correspondence with three-dimensional surface data of the apparatus;
the apparatus is provided in four different sizes, S, M, L, and XL, by means of 3D reverse modeling according to average values of human dental arch length and width; and an inner surface of the apparatus conforms to the morphology of the alveolar ridge of an edentulous patient.

2. An auxiliary scanning and data correction method for edentulous implant impressions using the auxiliary scanning and data correction apparatus for edentulous implant impressions according to claim 1, characterized by comprising:
numbering the apparatus, and scanning the apparatus by a high-precision three-dimensional scanning device to obtain three-dimensional surface data of the apparatus, wherein an identification number of the apparatus is in one-to-one correspondence with the three-dimensional surface data of the apparatus;
installing scan bodies on implants in the tooth bed of an edentulous patient, selecting an apparatus of an appropriate size according to the size of the dental arch of the edentulous patient and the positions and angles of the implants, and recording an identification number of the apparatus used;
matching a slot of the apparatus with the scan bodies, and connecting the apparatus to the scan bodies;
scanning the apparatus and the scan bodies using an intraoral scanner, and capturing identification features on surfaces of the scan bodies and irregular images on the surface of the apparatus, to obtain composite data comprising the apparatus and the scan bodies; and
scanning the apparatus by a high-precision three-dimensional scanning device, and taking three-dimensional surface data of the apparatus obtained by scanning as correction standard data;
the data correction method comprises:
performing virtual segmentation on the composite data according to the number of the scan bodies to obtain segmented composite data segments corresponding to the number of the scan bodies; finding the correction standard data of the apparatus according to the identification number of the apparatus, and correcting the segmented composite data segments to obtain a corrected scan model; and assisting in implant treatment for the edentulous patient using the corrected scan model;
the segmented composite data segments comprise irregular images on a corresponding part of the surface of the apparatus and corresponding scan bodies;
the correcting the segmented composite data segments specifically comprises the following steps:
matching the segmented composite data segments with corresponding correction standard data using matching AI-assisted correction software or dental design software, and adjusting data in the segmented composite data segments and irregular images on the surface of the apparatus based on the correction standard data, to obtain the corrected scan model;
the data correction is configured in the intraoral scanner, and performed simultaneously while the oral cavity of the edentulous patient is scanned, and a scan model output therefrom is transmitted via a signal to a PC for display and storage.
